(19) United States
(12) Patent Application Publication
(10) Pub. No.: US 2005/0217780 A1
(43) Pub. Date: Oct. 6, 2005

(54) Tire/wheel assembly

(76) Inventors: Kazuhiro Shimura, Hiratsuka-shi (JP); Takumi Sekiguchi, Hiratsuka-shi (JP); Mitsuru Naito, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/512,639

(22) PCT Filed: Jul. 23, 2003
(86) PCT No.: PCT/JP03/09321

§ 371 Date: Oct. 27, 2004

(30) Foreign Application Priority Data
Jul. 30, 2002 (JP) 2002-220690

(51) Int. Cl. B60C 17/02

(52) U.S. Cl. 152/520

(57) ABSTRACT

A tire/wheel assembly, wherein a run-flat support body (3), comprising an annular shell (4) having an outer peripheral side as a support surface and an inner peripheral side formed in fork-shaped open legs and elastic rings (5) supporting the ends of the legs on a rim, is inserted into a hollow part of a pneumatic tire (2), and wherein the height (A) of the run-flat support body (3) in the cross section thereof is 50 to 60% of the height (SH) of the pneumatic tire (2) in the cross section thereof, and wherein the cross sectional area of the bead cores (7) of the pneumatic tire (2) is 25 to 40 mm².

### TECHNICAL FIELD

The present invention relates to a tire/wheel assembly, more specifically, to a tire/wheel assembly offering enhanced run-flat durability without reducing mounting performance.

### BACKGROUND ART

Numerous-techniques for achieving emergency running for several hundred kilometers when a pneumatic tire blows out while driving a vehicle have been proposed to meet demands from the market. Among these numerous proposals, techniques, disclosed in Japanese Unexamined Patent Publication No. 10(1998)-297226 and in Japanese Translation of PCT International Application No. 2001-519279, achieve driving in a run-flat state by means of fitting a core onto a rim inside a hollow part of a pneumatic tire mounted on the rim, and by means of supporting the flat tire by the core.

The run-flat core (support body) has a configuration including an annular shell having an outer peripheral side as a support surface and having an inner peripheral side formed in fork-shaped open legs with elastic rings fitted thereto. The run-flat core is supported on the rim with the elastic rings. This run-flat core is directly applicable to a conventional wheel/rim without special alteration, and therefore the run-flat core has an advantage that the run-flat core is acceptable to the market without causing confusion.

Mileage that the tire/wheel assembly (a wheel) can run flat in the event of a blowout of the tire depends on durability of the run-flat support body. The durability of the run-flat support body can be extended longer as an outside diameter is greater. However, although an inside diameter of the run-flat support body is equal to an inside diameter of a bead part of the pneumatic tire, the outside diameter of the run-flat support body is formed greater than the inside diameter of the bead part. Accordingly, the run-flat support body is forcibly inserted into the inside of the pneumatic tire prior to the mounting. For this reason, an attempt to increase the run-flat durability merely by enlarging the outside diameter of the run-flat support body causes deterioration in mounting performance. Therefore, the increase in the outside diameter has a certain limitation.

Namely, in the conventional run-flat support body, when representing the outside diameter by the height A in the cross section thereof, it is thought to be limited to about 45% of the height SH of the pneumatic tire in the cross section thereof, and accordingly a further increase in the outside diameter is not adopted due to deterioration in the mounting performance. Therefore, measures to enhance the run-flat durability by increasing the outside diameter of the run-flat support body has been thought to be limited.

### DISCLOSURE OF THE INVENTION

An object of the present invention is to provide a tire/wheel assembly an outside diameter of a run-flat support body of which can be increased without reducing the mounting performance, and whose run-flat durability is further enhanced.

To attain the object, the present invention provides a tire/wheel assembly in which a run-flat support body including an annular shell having an outer peripheral side as a support surface and an inner peripheral side formed in fork-shaped open legs and elastic rings supporting the end parts of the fork-shaped open legs on a rim is inserted into a hollow part of a pneumatic tire, wherein a height A of the run-flat support body in the cross section thereof is set at 50 to 60% of a height SH of the pneumatic tire in the cross section thereof, and the cross sectional area of bead cores of the pneumatic tire is set at 25 to 40 mm².

When the pneumatic tire and the run-flat support body are mounted on the rim, an operation to insert the run-flat support body into the hollow of the pneumatic tire is required prior to the mounting. However, when the outside diameter of the run-flat support body is made greater by a certain degree than the inner diameter of the bead part of the tire, the run-flat support body cannot be inserted into the inside of the pneumatic tire and the mounting becomes impossible.

However, in the present invention, the cross sectional area of the bead cores is reduced to a range from 25 to 40 mm². Accordingly, the rigidity of the bead cores is reduced and an inside circumferential shape of the bead part can be transformed easily. Therefore, even when the outside diameter is enlarged by setting the height A of the run-flat support body in the cross section thereof at 50 to 60% of the height SH of the tire in the cross section thereof, it is possible to insert the run-flat support body easily into the inside of the pneumatic tire. Moreover, by enlarging the outside diameter of the run-flat support body, it is possible to further enhance the run-flat durability of the run-flat support body.

### BRIEF DESCRIPTION OF THE DRAWINGS

FIG. 1 is a meridional sectional view showing chief parts of a tire/wheel assembly according to an embodiment of the present invention.

FIG. 2 is a cross sectional view showing a bead part of a tire used in the tire/wheel assembly of FIG. 1.

FIG. 3 is a diagram of a run-flat support body set into a pneumatic tire.

### PREFERABLE MODES OF EMBODIMENT OF THE INVENTION

In the present invention, a run-flat support body is formed as an annular body to be inserted into a hollow part of a pneumatic tire. Of this run-flat support body, an outside diameter is formed smaller than an inside diameter of the hollow part so that a certain distance may be maintained between the outside diameter and an inner surface of the hollow part of the pneumatic tire, and an inside diameter is formed approximately the same dimension as an inside diameter of a bead part of the pneumatic tire. Moreover, this run-flat support body is mounted on a wheel together with the pneumatic tire while being inserted into the inside of the pneumatic tire, and is thereby formed into a tire/wheel assembly. When this tire/wheel assembly is fitted to a vehicle and the pneumatic tire blows out in a run, the tire, blown out and deflated, is supported by an outer surface of the run-flat support body, and thus run-flat driving can be achieved.

The run-flat support body includes an annular shell and elastic rings as chief parts.

The annular shell forms a continuous support surface on the outer peripheral side (the side of the outside diameter) for supporting the flat tire, and the inner peripheral side (the side of the inside diameter) thereof is formed with each side wall on the right and left shaped as if straddling. A cross sectional shape in the orthogonal direction to the circumferential direction of the support surface on the outer framework is formed into a convex surface so as to protrude towards the outside diameter. The number of convex portions of the annular shell located towards the outer framework may be one or more than one. However, when plural convex portions are provided, it is possible to spread load for supporting while driving in a run-flat state over the plurality of convex portions. Accordingly, it is possible to enhance the durability of the annular shell as a whole.

The elastic rings are respectively fitted to the end parts of the legs which are formed as if straddling the inside diameter side of the annular shell. The elastic rings are in close contact with rim sheets on the right and left, and thereby support the annular shell. The elastic ring is made of either rubber or elastic resin. In addition to buffering impacts and vibrations received by the annular shell from the flat tire, the elastic rings also have an antiskid function against the rim sheets so as to support the annular shell stably.

Since the run-flat support body of the present invention has to support a vehicle weight through the flat tire, the annular shell is made of a rigid material. Metal, resin or the like is used as a constituent material thereof. Steel, aluminum or the like can be taken as an example about the metal herein. The resin may be either thermoplastic resin or thermosetting resin. The thermoplastic resin includes nylon, polyester, polyethylene, polypropylene, polystyrene, polyphenylene sulfide, ABS, and the like. Meanwhile, the thermosetting resin includes epoxy resin, unsaturated polyester resin, and the like. Although the resin can be used alone, it is also possible to blend reinforcing fibers and use the resin as fiber-reinforced resin.

Now, the present invention will be described concretely with reference to the accompanying drawings.

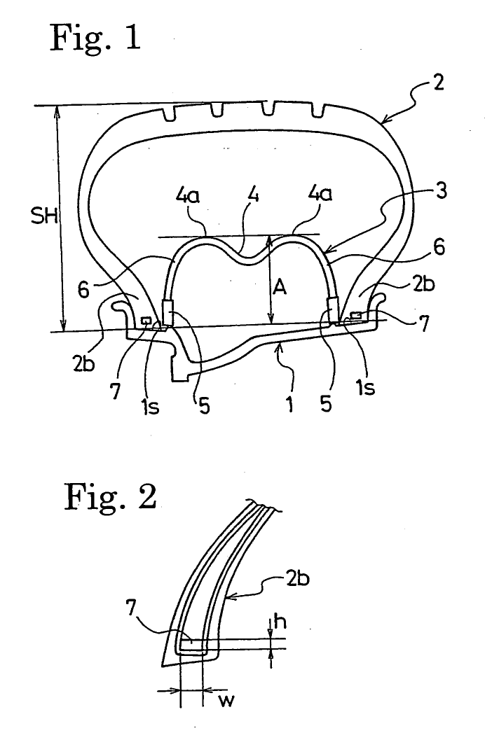

FIG. 1 is a cross sectional view in the width direction of the tire (a meridional sectional view) showing chief parts of a tire/wheel assembly (a wheel) according to an embodiment of the present invention.

Reference numeral 1 denotes a rim on an outer peripheral side of a wheel, reference numeral 2 denotes a pneumatic tire, and reference numeral 3 denotes a run-flat support body. The rim 1, the pneumatic tire 2, and the run-flat support body 3 are formed annularly around a shared axis with an unillustrated rotation axis of the wheel centered.

The run-flat support body 3 includes an annular shell 4 which is made of a rigid material such as metal or resin, and elastic rings 5 which are made of an elastic material such as hard rubber or elastic resin. The annular shell 4 includes convex portions 4a and 4a formed as two convex surfaces on the framework that are arranged in the width direction of the tire. Both sides on the inner framework of this annular shell 4 are formed in fork-shaped open legs respectively as legs 6 and 6, and the elastic rings 5 and 5 are fitted to the ends thereof.

Regarding the run-flat support body 3 configured as described above, the elastic rings 5 and 5 along with bead parts 2b and 2b are fitted to rim sheets 1s and 1s of the rim 1 while being inserted into the inside of the pneumatic tire 2. A bead core 7 is embedded annularly in the circumferential direction of the tire in each of the bead parts 2b. Rigidity is provided to the bead part 2b by embedding this bead core 7. The bead core 7 is formed by winding a steel wire annularly several times.

In the above-described configuration, the height A of the run-flat support body 3 in the cross section thereof (the height in the radial direction from the inner circumference to the outermost circumference) is formed in the size equivalent to 50 to 60% of the height SH of the pneumatic tire 2 in the cross section thereof (the height in the radial direction from the inner circumference of the bead part to an outer circumference of a tread), more preferably, equivalent to 51 to 55% thereof. Since the height A of the run-flat support body 3 in the cross section thereof is set equal to, or greater than, 50% of the height SH of the tire in the cross section thereof, the outside diameter is increased as compared to the conventional run-flat support body only having the height which is about 45% of the height SH of the tire in the cross section thereof at the utmost. Therefore, the run-flat durability of the run-flat support body 3 is further enhanced. However, when the height A of the run-flat support body in the cross section thereof exceeds 60% of the height SH of the tire in the cross section thereof, it is impossible to insert the run-flat support body into the tire even if rigidity of the bead core is reduced by decreasing the cross sectional area of the bead core 7 as described later.

When the height A of the run-flat support body 3 in the cross section thereof is set at 50 to 60% of the height SH of the tire in the cross section thereof, it is not possible to insert the run-flat support body 3 directly into the inside of the pneumatic tire 2 due to an increase in the outside diameter of the run-flat support body 3. For this reason, in the tire/wheel assembly of the present invention, the rigidity of the bead core 7 is reduced by decreasing the cross sectional area of the bead core 7 of the pneumatic tire 2 in the range from 25 to 40 mm². That is to say, the inside circumferential shape of the bead part 2b can be transformed easily; accordingly, it is possible to insert the run-flat support body 3 into the inside of the pneumatic tire 2 even when the outside circumference is larger.

When the cross sectional area of the bead core 7 is larger than 40 mm², it is impossible to insert the run-flat support body 3 having the increased outside circumference as described above. On the other hand, when the cross sectional area is smaller than 25 mm², the support of the tire by the rim becomes unstable. Although the cross sectional area of the bead core 7 of the pneumatic tire 2 used in the present invention is reduced to the range from 25 to 40 mm², the support does not become unstable because the leg 6 and the elastic ring 5 of the run-flat support body 3 press the inside of the bead part 2b.

In the present invention, in addition to reducing the cross sectional area of the bead core 7 to a certain amount as described above, when the cross sectional shape of the bead core 7 is so depressed that a width w in the direction of the tire axis is greater than a height h in the radial direction as shown in FIG. 2, it is possible to render insertion of the run-flat support body 3 into the inside of the pneumatic tire 2 easier. That is to say, even when the cross sectional area of the bead core is unchanged, this measure makes it even easier to bend the run-flat support body.

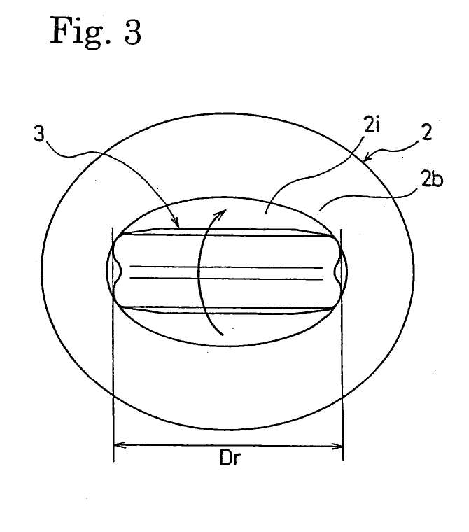

FIG. 3 is a diagram for an operation of inserting the run-flat support body into the inside of the pneumatic tire.

As shown in FIG. 3, firstly, the pneumatic tire 2 is placed horizontally, and the run-flat support body 3 is pushed into a position of a maximum diameter Dr of an inside circumferential part 2i of the bead part 2b thereof while the diametrical direction of the run-flat support body 3 is set upright. By pushing the run-flat support body 3 having the outside diameter Dr which is larger than the inside diameter of the bead part 2b of the pneumatic tire 2 as described above, the inside circumferential part 2i of the bead part 2b is transformed into an elliptical shape.

Subsequently, when the run-flat support body 3 is turned pivotally around the longitudinal axis direction of the ellipse from the state where the run-flat support body 3 is fitted as shown in the drawing and is thereby put horizontally, the run-flat support body 3 shares the rotation axis with the tire. Accordingly, the run-flat support body 3 is concentrically inserted into the inside of the pneumatic tire 2. Thereafter, the tire/wheel assembly can be assembled by mounting in accordance with the same operation for mounting a normal tire with a tire mounter.

According to the above-described operation, it is possible to increase the maximum diameter Dr of the run-flat support body 3 to be insertable to the pneumatic tire 2 with larger allowance of buckling the inside circumferential part 2i of the bead part 2b of the pneumatic tire 2 into the elliptical shape. As described above, the present invention has designed the allowance of transforming the inside circumferential part 2i of the bead part 2b of the pneumatic tire into the elliptical shape, with the relation between the mounting performance and a tire supporting property taken into consideration, by defining the cross sectional area of the bead core as 25 to 40 mm², and the maximum diameter Dr of the run-flat support body in terms of the height A in the cross section thereof (the height in the radial direction from the inner circumference to the outermost circumference) to be set at 50 to 60% of the height SH of the pneumatic tire in the cross section thereof (the height in the radial direction from the inner circumference of the bead part to the outer circumference of the tread).

In the present invention, the sizes of the pneumatic tire and the rim used for the tire/wheel assembly are not particularly limited. However, it is preferable to use a pneumatic tire having a code indicating a tire width, among standard sizes which are standardized by JATMA, in a range from 175 to 285 mm, or more preferably in a range from 185 to 285 mm. An aspect ratio of the pneumatic tire for use is preferably set at 50 to 65%, or more preferably set at 55 to 60%. Moreover, regarding the rim, it is preferable to use a rim having a code indicating a rim diameter from 15 to 18 inches, or more preferably from 16 to 17 inches.

### EXAMPLES

With 205/55R16 and 16×6 1/2JJ applied respectively as common tire size and rim size, seven types of tire/wheel assemblies (which are a conventional example, comparative examples 1 and 2, and embodiments 1 to 4) having various ratios of the height A of the run-flat support body in the cross section thereof relative to the height SH of the tire in the cross section thereof and various cross sectional areas of the bead core were manufactured.

Regarding these seven types of tire/wheel assemblies, ease of performing an inserting operation of the run-flat support body into the inside of the pneumatic tire (insertion operability), and the run-flat durability of the run-flat support body have been measured in accordance to the measurement method described below. Results are shown in Table 1.

[Run-Flat Durability]

Each tire/wheel assembly for testing was fitted to the left front side of a passenger car of 2500 cc displacement with a tire pressure set at 0. Meanwhile, the tire pressure for the other tires was set at 200 kPa. Then, a test driver drove the car around a circuit track at 90 km/h until the run-flat support body broke down, and the mileage at that point was measured. Evaluation is indicated with an index where the mileage measured by use of the conventional tire/wheel assembly is taken as 100. Accordingly, a larger index represents superior run-flat durability.

TABLE 1

| | | Cross sectional | | Run-flat |
|---|---|---|---|---|
| | A/SH | area of bead core | Insertion | durability |
| | (%) | (mm²) | operability | (index) |
| Conventional | 45 | 45 | fine | 100 |
| Example | | | | |
| Comparative | 50 | 45 | not possible | — |
| Example 1 | | | | |
| Example 1 | 50 | 40 | possible | 110 |
| Example 2 | 60 | 25 | possible | 118 |
| Comparative | 62 | 25 | not possible | — |
| Example 2 | | | | |
| Example 3 | 51 | 30 | fine | 112 |
| Example 4 | 55 | 35 | fine | 115 |

As described above, according to the present invention, the height A of the run-flat support body in the cross section thereof is set at 50 to 60% of the height SH of the pneumatic tire in the cross section thereof, and the cross sectional area of the bead core of the pneumatic tire is 25 to 45 mm². In this way, it is possible to facilitate an insertion operation of the run-flat support body having a larger outside diameter into the inside of the pneumatic tire by means of reducing rigidity of the bead core. Moreover, it is possible to further enhance the run-flat durability by enlarging the outside diameter of the run-flat support body without reducing the mounting performance.

1. A tire/wheel assembly in which a run-flat support body including an annular shell having an outer peripheral side as a support surface and an inner peripheral side formed in fork-shaped open legs and elastic rings supporting the ends of the fork-shaped open legs on a rim is inserted into a hollow part of a pneumatic tire,
wherein a height A of the run-flat support body in the cross section thereof is set at 50 to 60% of a height SH of the pneumatic tire in the cross section thereof, and
the cross sectional area of a bead core of the pneumatic tire is set at 25 to 40 mm².

2. The tire/wheel assembly according to claim 1,
wherein the height A of the run-flat support body in the cross section thereof is set at 51 to 55% of the height SH of the pneumatic tire in the cross section thereof.

3. The tire/wheel assembly according claim 1,
wherein the cross sectional area of the bead core of the pneumatic tire is set at 30 to 35 mm².

4. The tire/wheel assembly according to claim 1,
wherein a cross sectional shape of the bead core is so depressed that a width in the direction of the axis of the tire is larger than a height in the radial direction of the tire.

5. The tire/wheel assembly according to claim 1,
wherein a code indicating a tire width of the pneumatic tire is 175 to 285 mm.

6. The tire/wheel assembly according to claim 1,
wherein an aspect ratio of the pneumatic tire is 50 to 65%.

7. The tire/wheel assembly according to claim 1,
wherein a code indicating a rim diameter of the wheel is 15 to 18 inches.

8. The tire/wheel assembly according claim 2,
wherein the cross sectional area of the bead core of the pneumatic tire is set at 30 to 35 mm².

9. The tire/wheel assembly according to claim 2,
wherein a cross sectional shape of the bead core is so depressed that a width in the direction of the axis of the tire is larger than a height in the radial direction of the tire.

10. The tire/wheel assembly according to claim 2,
wherein a code indicating a tire width of the pneumatic tire is 175 to 285 mm.

11. The tire/wheel assembly according to claim 2,
wherein an aspect ratio of the pneumatic tire is 50 to 65%.

12. The tire/wheel assembly according to claim 2,
wherein a code indicating a rim diameter of the wheel is 15 to 18 inches.

13. The tire/wheel assembly according to claim 3,
wherein a cross sectional shape of the bead core is so depressed that a width in the direction of the axis of the tire is larger than a height in the radial direction of the tire.

14. The tire/wheel assembly according to claim 3,
wherein a code indicating a tire width of the pneumatic tire is 175 to 285 mm.

15. The tire/wheel assembly according to claim 3,
wherein an aspect ratio of the pneumatic tire is 50 to 65%.

16. The tire/wheel assembly according to claim 3,
wherein a code indicating a rim diameter of the wheel is 15 to 18 inches.

17. The tire/wheel assembly according to claim 4,
wherein a code indicating a tire width of the pneumatic tire is 175 to 285 mm.

18. The tire/wheel assembly according to claim 4,
wherein an aspect ratio of the pneumatic tire is 50 to 65%.

19. The tire/wheel assembly according to claim 4,
wherein a code indicating a rim diameter of the wheel is 15 to 18 inches.

20. The tire/wheel assembly according to claim 5,
wherein an aspect ratio of the pneumatic tire is 50 to 65%.

21. The tire/wheel assembly according to claim 5,
wherein a code indicating a rim diameter of the wheel is 15 to 18 inches.

22. The tire/wheel assembly according to claim 6,
wherein a code indicating a rim diameter of the wheel is 15 to 18 inches.
